(19) United States
(12) Patent Application Publication
(10) Pub. No.: US 2005/0086413 A1
(43) Pub. Date: Apr. 21, 2005

(54) Capacity Expansion of Flash Memory Device with a Daisy-Chainable Structure and an Integrated Hub

(75) Inventors: Edward W. Lee, Mountain View, CA (US); Tzu-Yih Chu, San Jose, CA (US)

Correspondence Address: STUART T AUVINEN, 429 26TH AVENUE, SANTA CRUZ, CA, 95062-5319, US

(73) Assignee: SUPER TALENT ELECTRONICS INC., San Jose, CA (US)

(21) Appl. No.: 10/605,636

(22) Filed: Oct. 15, 2003

(51) Int. Cl. G06F 13/20

(52) U.S. Cl. 710/313

(57) ABSTRACT

A chainable Universal-Serial-Bus (USB) flash-memory drive has both a female USB connector and a male USB connector mounted on a printed-circuit board (PCB) substrate. A USB hub mounted on the substrate connects to a host through the male USB connector. One of the ports of the USB hub is connected to the female USB connector to allow the host to connect to downstream USB devices connected to the chainable USB flash-memory drive. Other ports of the USB hub connect to one or more flash controller chips that drive flash memory chips. The flash memory chips may be mounted on the substrate, or may be on daughter-cards that plug into sockets on the chainable USB flash-memory drive's substrate. The flash controller chip may be mounted on the drive substrate or on the daughter-cards. Several chainable USB flash-memory drives may be connected together in a daisy chain.

### BACKGROUND OF INVENTION

This invention relates to flash memory devices, and more particularly to flash memory devices with a daisy-chainable structure and an integrated hub.

Flash memory, or electrically-erasable programmable read-only memory, (EEPROM), is widely used today. Flash memory is non-volatile, not losing data when power is removed. Non-volatile flash memory is especially useful for small consumer devices such as digital cameras, music players, personal digital assistants (PDA's), etc.

Flash memory can also be used to expand the storage capacity of a personal computer (PC). Flash memory devices generally come in two forms: flash-memory drives (or flash drives) and flash-memory cards (or flash cards). External peripherals known as flash-memory drives connect to the PC using interfaces such as Universal-Serial-Bus (USB), IEEE 1394 (firewire), integrated device electronics (IDE), Advanced Technology Attachment (ATA), or serial ATA (SATA). Adapters for various flash-memory cards are also known, such as secure-digital (SD), memory-stick (MS), or compact-flash (CF) cards that may be adapted to a PC through a Personal Computer Memory Card International Association (PCMCIA) port. Readers/adapters for flash-memory cards, such as compact-flash (CF) card readers that connect to a PC through a USB or firewire port are also known.

More recently, small USB flash-memory drives have become available. These drives have a USB connector often mounted to a printed-circuit board (PCB) containing flash memory. The drive can be plugged into a USB port of a host PC, allowing the PC to read or write the flash memory. The small size of flash-memory devices allows for easy transport. The USB flash-memory drives can be attached to a key ring and are sometimes called USB key-drives or USB mini-drives. Or they are made into the shape of a pen and called USB pen-drives. These USB flash-memory drives are marketed as floppy-disk replacements.

FIG. 1 shows a prior-art USB flash-memory drive. Substrate 30 is a fiberglass or other kind of PCB and can have multiple wiring layers to allow for a small area. Flash memory chip 33 is mounted to substrate 30 and stores data. Flash memory controller chip 32 controls reading and writing of flash memory chip 33, and also converts the flash memory data to and from serial data that is sent over a USB link to a PC or other host. Connector 38 is a USB connector with metal contacts for the standard power, ground, and differential data D+, D− lines. Controller chip 32 also acts as a USB controller and data converter. Substrate 30 can be covered by a plastic case for protection.

While such a USB flash-memory drive is useful, the amount of flash memory available is limited by the capacity of flash memory chip 33. While capacities of flash memory chip 33 are improving, currently such chips hold only 64, 128 or 256 Megabytes of data. However, much larger memory capacity is often required for many storage applications.

What is desired is an expandable USB flash-memory drive. A portable flash-memory card that can be expanded in memory capacity is also desired.

### BRIEF DESCRIPTION OF DRAWINGS

FIG. 1 shows a prior-art USB flash-memory drive.

FIG. 2 shows a daisy-chainable USB flash-memory drive with an integrated USB hub.

FIG. 3A is a diagram of a daisy-chainable USB flash-memory drive.

FIG. 3B,C show several daisy-chainable USB flash-memory drives connected together in a daisy chain.

FIG. 4 is a diagram of a chainable USB flash-memory drive with memory-card sockets.

FIG. 5 shows a chainable USB flash-memory drive with sockets for daughter-cards directly connected to the USB hub.

FIGS. 6A-H shows daughter-cards containing flash memory chips for plugging into sockets on the chainable USB flash-memory drive.

FIG. 7 shows a non-chainable USB flash-memory drive using an integrated USB hub to expand memory capacity.

FIG. 8 shows a non-chainable USB flash-memory drive using an integrated USB hub and sockets for daughter-cards with flash memory chips.

FIG. 9 shows a non-chainable USB flash-memory drive using an integrated USB hub and sockets for daughter-cards with both flash memory chips and the flash memory controller chip.

### DETAILED DESCRIPTION

The present invention relates to improvements in flash-memory drives and cards. The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

The inventors have realized that a USB flash-memory drive can be made expandable by adding a USB hub and a second USB connector of the female type to it. The second USB connector allows for daisy-chaining of USB flash-memory drives, since another USB flash-memory drive can be plugged into the second USB connector. Thus a daisy-chainable USB flash-memory drive is produced.

USB devices other than flash drives, such as printers, mice, scanners, etc. may also be plugged into the second USB connector of the daisy-chainable USB flash-memory drive, allowing the host PC to communicate by down-streaming through the chainable USB flash-memory drive. This feature can be very useful when there are no more USB ports available on the host device.

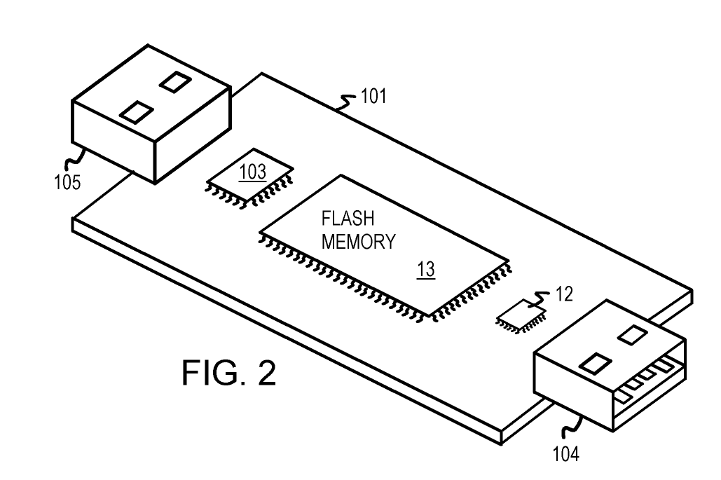

FIG. 2 shows a daisy-chainable USB flash-memory drive with an integrated USB hub. Male USB connector 104 fits into a female USB connector on the host device, such as on a PC or digital music player. Male USB connector 104 is mounted on substrate 101. Female USB connector 105 can be mounted on the opposite or another edge of substrate 101. Substrate 101 can be a multi-layer PCB that has wiring traces that connect flash memory chip 13, flash memory controller chip 12, USB hub chip 103 and USB connectors 104, 105.

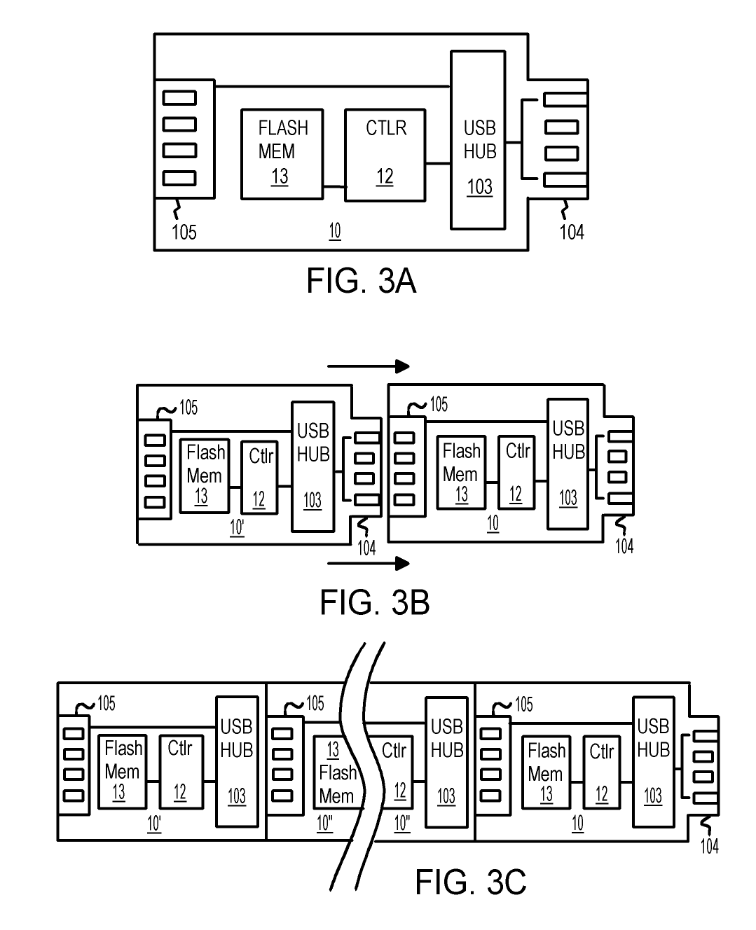

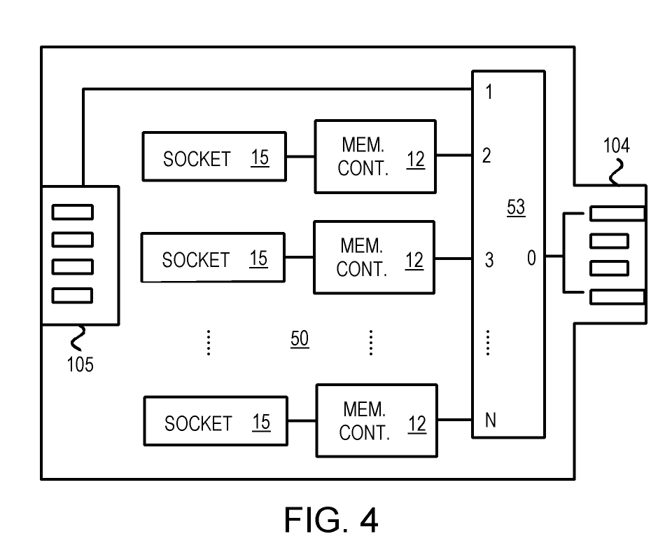

FIG. 3A is a diagram of a daisy-chainable USB flash-memory drive. Flash memory chip 13 can be either the NAND or the NOR-type of flash memory. Although only one chip is shown, it could be made of multiple chips. Flash memory controller chip 12 generates data and control signals needed by the particular type of flash memory chip 13.

USB hub chip 103 is configured by the host through male USB connector 104, when the host detects that the chainable USB flash-memory drive 10 has been plugged into its USB port. Flash memory chip 13 is mounted onto substrate 101, and is controlled by flash memory controller chip 12. Together they form an on-board USB flash-memory drive. USB hub chip 103 is also mounted on substrate 101, and acts as a USB hub, passing USB data and commands received from the host over male USB connector 104 to downstream USB devices, including the one connected to female USB connector 105 and the USB flash-memory drive built on-board. Data and status requested by the host are received by USB hub 103 over female USB connector 105 or they are received from flash memory chip 13 through the flash-memory controller chip 12 and then sent to the host over male USB connector 104.

USB hub chip 103 may perform a variety of USB hub functions. Basic USB 1.x hub functions can include determining when new hot-plug USB devices are plugged in downstream, and retrieving configuration information from these devices to send to the host controller. More advanced USB 2.0 functions can include split transaction processing. Transfers from the host to USB hub 103 can be performed at high speed (480 Mbps) while transfers from USB hub 103 to downstream USB devices can be performed at the high speed, or at lower “full speed” (12 Mbps) or “low speed” (1.5 Mbps) rates. USB hub 103 can buffer high-speed transfers from the host, releasing the upstream bus to the host while more slowly transferring data to the downstream USB device. Start-split and complete-split transactions can be performed over the host bus.

Various transfer types can be supported from the host through USB hub chip 103, such as higher-priority isochronous or lower-priority bulk transfers, control transfers of device configuration information, and interrupt transfers of device status information. Several different transfers to different USB devices can be performed in each frame or micro-frame as scheduled by software on the host.

FIGS. 3B, 3C show several daisy-chainable USB flash-memory drives connected together in a daisy chain. FIG. 3B shows two USB flash-memory drives being fitted together. In FIG. 3C end chainable USB flash-memory drive 10′, middle chainable USB flash-memory drives 10″, and first chainable USB flash-memory drive 10 are connected together by USB connectors. Male USB connector 104 of the first of middle chainable USB flash-memory drives 10″ plugs into female USB connector 105 of first chainable USB flash-memory drive 10. Male USB connector 104 of end chainable USB flash-memory drive 10′ plugs into female USB connector 105 of the last of middle chainable USB flash-memory drives 10″. Each pair of adjacent middle chainable USB flash-memory drives 10″ is connected together by a male USB connector 104 on the left-side flash-memory drive plugging into a female USB connector 105 on the right-side flash-memory drive.

When the host (connected to male USB connector 104 of first chainable USB flash-memory drive 10) desires to write data to flash-memory chip 13 of end chainable USB flash-memory drive 10′, then USB hub chips 103 on each chainable USB flash-memory drive 10, 10″ pass the USB data and commands through to the female USB connector 105 on the chainable USB flash-memory drive. Once the USB data reaches USB hub chip 103 on end chainable USB flash-memory drive 10′, then the USB data is sent to flash controller chip 12 for storage by flash memory chip 13 on end chainable USB flash-memory drive 10′. Each USB hub chip 103 on each chainable USB flash-memory drive examines the USB commands to see if the USB data is addressed to its flash memory chip 13. If not, the USB commands and data are passed through to female USB connector 105 and to the next downstream chainable USB flash-memory drive.

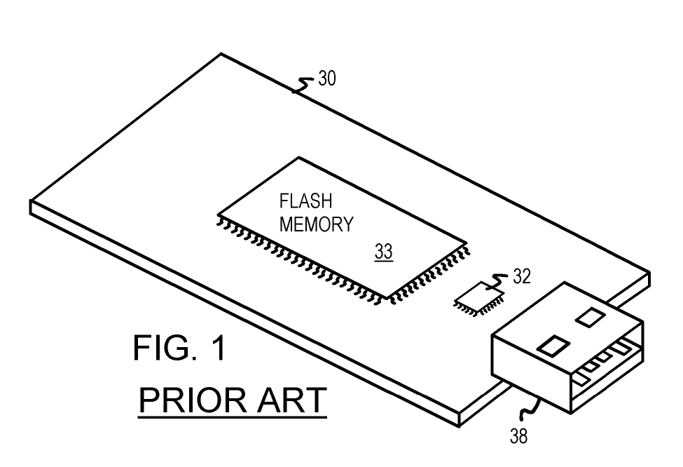

Several chainable USB flash-memory drives 10, 10″, 10′ may be chained together. The host can configure each USB hub chip 103 on each chainable USB flash-memory drive 10, 10′, 10″ to respond to a different USB device address. Other kinds of USB devices may be substituted for end chainable USB flash-memory drive 10′, such as the prior art flash-memory drive shown in FIG. 1. The host keeps track of what kind of USB devices are attached to each of the host's USB ports, and assigns a USB address to each USB device. When new USB devices are plugged into the end of the chain, the host detects the presence of the new USB device and configures it.

The total memory capacity is expanded from that of flash memory chip 13 in first chainable USB flash-memory drive 10 by the number of chainable USB flash-memory drives 10, 10′, 10″ connected together. For example, when 4 chainable USB flash-memory drives are connected together, the memory capacity is quadrupled. The memory sizes of each chainable USB flash-memory drive may differ, such as when a 64 MB drive is plugged into a 128 MB drive, yielding a total capacity of 192 MB.

While desktop PC's often have plenty of USB ports, other hosts such as smaller PC's and hand-held devices may have few USB ports and might benefit from the pass-through capability of the chainable USB flash-memory drive. For example, a digital camera or music player with just one USB port could have a chainable USB flash-memory drive plugged in. The USB port of the chainable USB flash-memory drive could still be used to connect the digital camera with a host PC. The PC could read flash data from the chainable USB flash-memory drive or from the digital camera over the same USB chain.

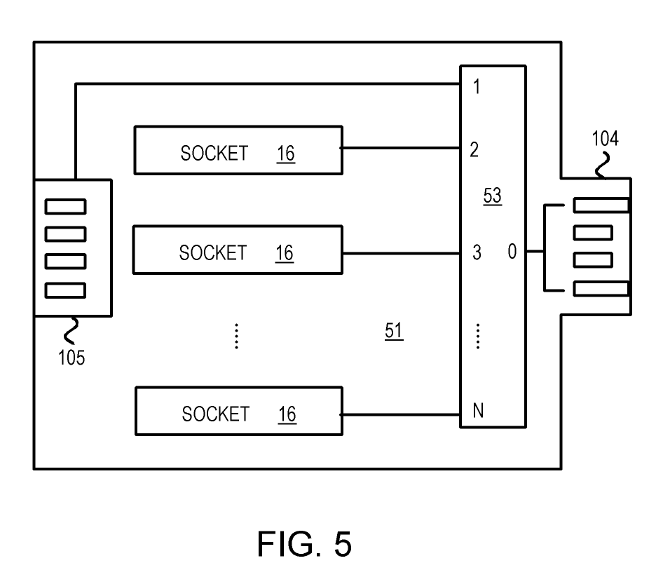

FIG. 4 is a diagram of a chainable USB flash-memory drive with memory-card sockets. USB hub 53 is mounted in PCB substrate 50 and connects to male USB connector 104 and female USB connector 105 by wiring traces on substrate 50. USB hub 53 has N ports, plus the upstream or host port that connects to male USB connector 104. One port (shown as port 1) of USB hub 53 connects downstream to other USB device or to a host port of another USB hub over female USB connector 105.

Each of ports 2 through N of USB hub 53 connects to a flash memory controller 12. Each flash memory controller 12 connects to a socket 15 that is mounted on substrate 50. A smaller daughter-card containing flash memory chips can be inserted into each socket 15. Each flash memory controller 12 controls the flash memory chips on the daughter-card plugged into its socket 15.

The number of ports N supported by USB hub 53 may be four, eight, or some other number. The number N does not include the upstream host port, which is called port 0 by convention. One or more of the N ports may drive flash controller chips and flash memory chips that are directly mounted on PCB substrate 50 while other ports drive sockets to daughter-cards that have the flash memory chips mounted thereon.

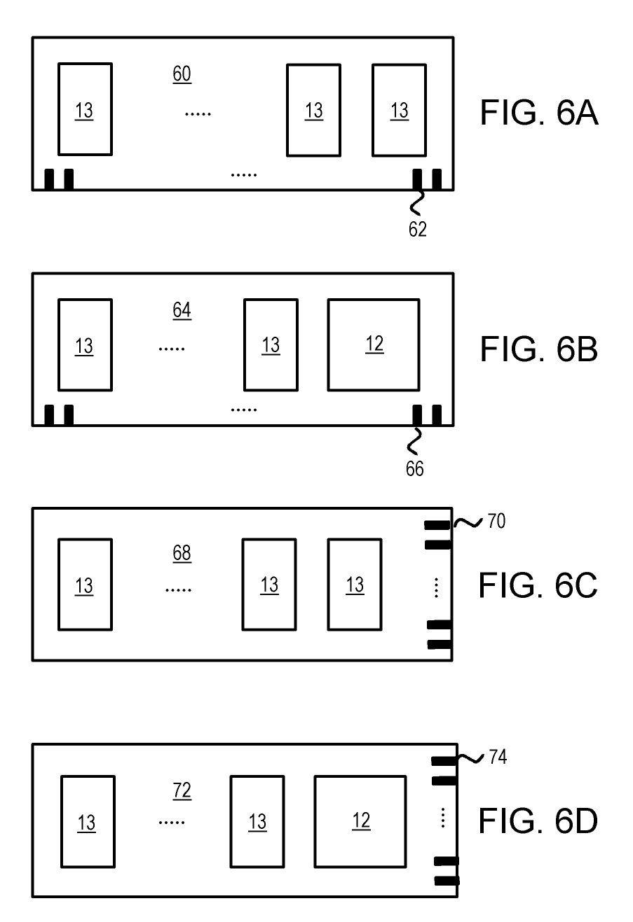

FIG. 5 shows a chainable USB flash-memory drive with sockets for daughter-cards directly connected to the USB hub. Rather than mount directly on PCB substrate 51, the flash memory controller chips can be mounted on the daughter-cards plugged into sockets 16. Thus USB hub 53 connects directly to sockets 16 for ports 2 to N. Port 1 of USB hub 53 connects downstream to other USB device or a host port of another USB hub through female USB connector 105. One or more of N ports could drive flash controller chips and flash memory chips that are directly mounted on PCB substrate 51 while the other ports drive sockets to daughter-cards that have the flash memory chips and flash controller chips mounted thereon.

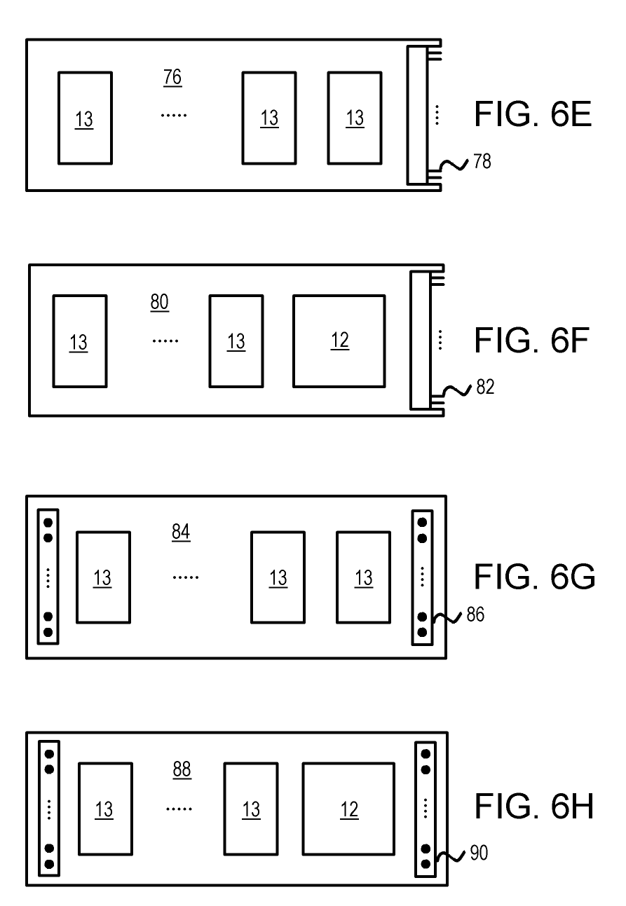

FIGS. 6A-H shows daughter-cards containing flash memory chips for plugging into sockets on the chainable USB flash-memory drive. FIG. 6A shows daughter-card 60 that has flash memory chips 13 mounted on its substrate. Metal edge contacts 62 are arrayed along the bottom edge of the substrate, and fit in socket 15 of FIG. 4. Flash memory chips 13 on daughter-card 60 are driven through socket 15 and metal edge contacts 62 by flash controller chips 12 mounted on the chainable USB flash-memory drive substrate 50.

FIG. 6B shows daughter-card 64 that has flash memory chips 13 and flash controller chip 12 mounted on its substrate. Metal edge contacts 66 are arrayed along the bottom edge of the substrate, and fit in socket 16 of FIG. 5. Flash controller chip 12 generates control signals for flash memory chips 13. Both flash controller chip 12 and flash memory chips 13 are mounted on daughter-card 64. Flash controller chip 12 is driven through socket 16 and metal edge contacts 66 by USB hub 53 mounted on the chainable USB flash-memory drive substrate 51.

FIGS. 6C, 6D shows that the metal edge contacts may be arrayed along the smaller side edge rather than the longer bottom edge. In FIG. 6C, metal edge contacts 70 are arrayed along the side edge of daughter-card 68. A smaller socket 15 may be used to carry signals from flash controller chip 12 to flash memory chips 13 on daughter-card 68. The size and pitch of metal edge contacts 70 may be reduced in this embodiment. In FIG. 6D, metal edge contacts 74 are arrayed along the side edge of daughter-card 72, and carry signals from USB hub 53 to flash controller chip 12 that drives flash memory chips 13.

FIGS. 6E, 6F shows that post connectors may be used rather than metal edge contacts. In FIG. 6E, posts 78 are male-type connectors that fit in a female-type plug on socket 15 on substrate 50 of FIG. 4. Posts 78 can be mounted on the side edge of daughter-card 76. Posts 78 carry signals to flash memory chips 13. Posts 78 could also be located on the bottom edge or another place on daughter-card 76.

In FIG. 6F, posts 82 are male-type connectors that fit in a female-type plug on socket 16 on substrate 51 of FIG. 5. Posts 82 can be mounted on the side edge of daughter-card 80. Posts 82 carry signals to flash controller chip 12 that drives flash memory chips 13. Posts 82 could also be located on the bottom edge or another place on daughter-card 80.

FIGS. 6G, 6H shows post connectors mounted on the top surface of the daughter-cards. In FIG. 6G, posts 86 are male-type connectors that fit in a female-type plug on socket 15 on substrate 50 of FIG. 4. Posts 86 could also be mounted on the bottom surface of daughter-card 84. Posts 86 carry signals to flash memory chips 13.

In FIG. 6H, posts 90 are male-type connectors that fit in a female-type plug on socket 16 on substrate 51 of FIG. 5. Posts 90 could also be mounted on the bottom surface of daughter-card 88. Posts 90 carry signals to flash controller chip 12 that drives flash memory chips 13.

For FIGS. 6A-D, metal edge contacts may be populated on one side or on both the front and reverse sides of the daughter-cards. For FIGS. 6E-H, rather than use male connectors on the daughter-cards and female connectors on the chainable USB flash-memory drive, the connectors could be reversed. The female connectors could be mounted on the daughter-cards while the male connectors are mounted on the PCB substrate of chainable USB flash-memory drive. Furthermore, either single or dual-in-line connectors could be utilized.

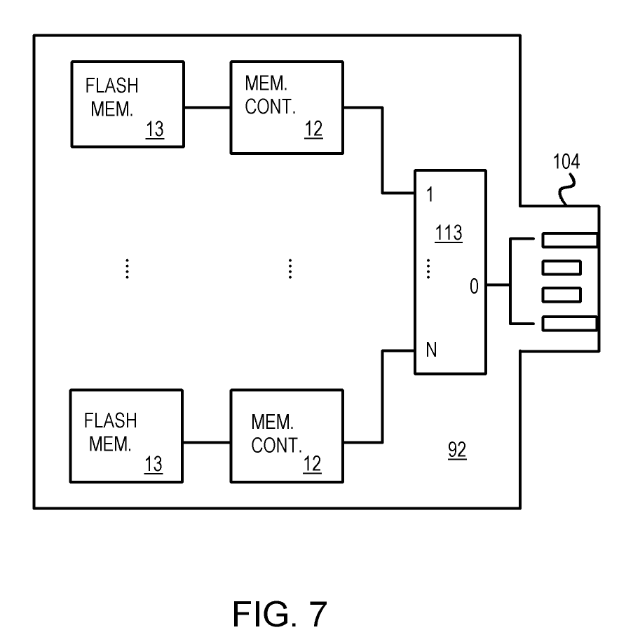

FIG. 7 shows a non-chainable USB flash-memory drive using an integrated USB hub to expand total memory capacity. PCB substrate 92 has male USB connector 104 mounted thereon for connecting to a host, and flash controller chips 12 controlling flash memory chips 13 through ports 1 to N of USB hub 113. A female USB connector is not included.

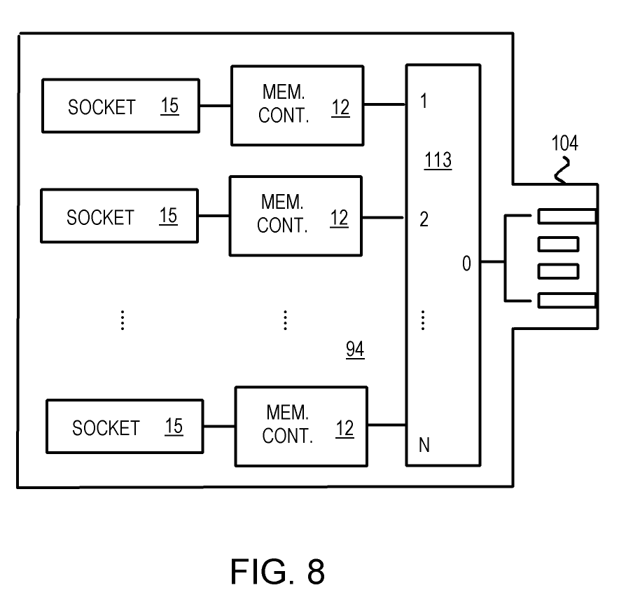

FIG. 8 shows a non-chainable USB flash-memory drive using an integrated USB hub and sockets for daughter-cards with flash memory chips. PCB substrate 94 has male USB connector 104 mounted thereon for connecting to a host, and flash controller chips 12 controlling flash memory chips 13 through ports 1 to N of USB hub 113. Sockets 15 couple flash controller chips 12 to flash memory chips 13 that are mounted on daughter-cards inserted into sockets 15.

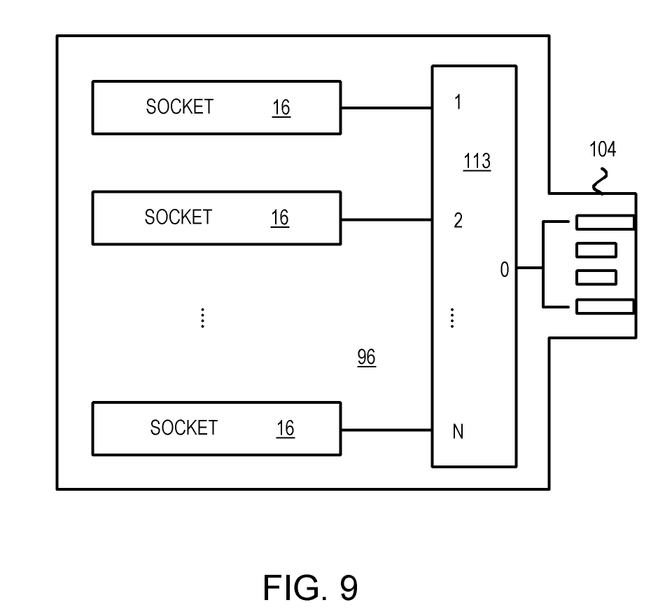

FIG. 9 shows a non-chainable USB flash-memory drive using an integrated USB hub and sockets for daughter-cards with both flash memory chips and the flash controller chip. PCB substrate 96 has male USB connector 104 mounted thereon for connecting to a host, and sockets 16 connected to ports 1 to N of USB hub 113. Sockets 16 couple USB hub 113 to flash controller chips 12 and flash memory chips 13 that are mounted on daughter-cards inserted into sockets 16.

ALTERNATE EMBODIMENTS

Several other embodiments are contemplated by the inventors. For example the flash controller chip and the USB hub chip in FIG. 2 and FIGS. 3A-C could be integrated together as one integrated circuit chip. Rather than flash memory chips, other kinds of memory (ROM, EPROM, EEPROM, FRAM, MRAM, etc) or small hard disk drives (IDE, ATA, SATA, etc) may be used.

Sockets for daughter-cards could be mixed with on-board flash memory chips that are mounted on the card's substrate. For example, port 2 of USB hub 53 in FIG. 4 could connect to a flash controller chip 12 that connects to a flash memory chip 13 that is mounted directly on substrate 50, rather than through a socket 15. Other ports 3 to N could connect to flash controller chips 12 that connect to sockets 15.

The number of ports N on the card may be less than the number of ports on or supported by USB hub 53. Multiple USB hubs 53 could also be used. Not all sockets need to be populated with daughter-cards. The male USB connector and the female USB connector can be mounted on opposite sides of the drive substrate, or could be on adjacent sides or on the same side, or at various angles and orientations to each other.

Other kinds of connectors and hubs besides USB may be substituted. For example, based on FIG. 3A, a chainable firewire flash-memory drive may be constructed by replacing male USB connector 104 and female USB connector 105 with a pair of male and female firewire (IEEE 1394) connectors, USB hub 103 with a firewire hub and replacing USB flash controller 12 with a firewire flash controller. Other connectors such as compact-flash (CF), secure-digital (SD), multi-media-card (MMC), memory-stick (MS), USB Express Card, PCI Express Card, etc. could also be used, with the appropriate hub and flash controllers for that particular industry standard. Variations of these standards may also be supported, such as USB on-the-go, IEEE 1394B, etc. Other combinations are possible. Many variations or types of USB connectors are known, such as mini connectors as well as standard connectors.

The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. 37 C.F.R. § 1.72(b). Any advantages and benefits described may not apply to all embodiments of the invention. When the word “means” is recited in a claim element, Applicant intends for the claim element to fall under 35 USC § 112, paragraph 6. Often a label of one or more words precedes the word “means″. The word or words preceding the word “means” is a label intended to ease referencing of claims elements and is not intended to convey a structural limitation. Such means-plus-function claims are intended to cover not only the structures described herein for performing the function and their structural equivalents, but also equivalent structures. For example, although a nail and a screw have different structures, they are equivalent structures since they both perform the function of fastening. Claims that do not use the word means are not intended to fall under 35 USC §112, paragraph 6. Signals are typically electronic signals, but may be optical signals such as can be carried over a fiber optic line.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. A chainable Universal-Serial-Bus (USB) flash-memory drive comprising:
a drive substrate having wiring traces for electrically connecting components;
a USB hub, mounted on the drive substrate, having a host port and a plurality of device ports;
a male USB connector mounted on the drive substrate, connected by the wiring traces to the USB hub;
a female USB connector mounted on the drive substrate, connected by the wiring traces to the USB hub;
a flash controller mounted on the drive substrate, connected by the wiring traces to one of the plurality of device ports of the USB hub; and
a flash memory mounted on the drive substrate, connected by the wiring traces to the flash controller, for storing data received by the USB hub through the host port,
whereby the drive substrate has mounted thereon the male USB connector, the female USB connector, the USB hub, the flash controller, and the flash memory.

2. The chainable USB flash-memory drive of claim 1 wherein the male USB connector connects to the host port of the USB hub;
wherein the female USB connector connects to one of the plurality of device ports of the USB hub.

3. The chainable USB flash-memory drive of claim 2 wherein the female USB connector can connect to the male USB connector of a downstream chainable USB flash-memory drive allowing a host connected to the male USB connector of the chainable USB flash-memory drive to read flash memory from either the chainable USB flash-memory drive or from the downstream chainable USB flash-memory drive,
whereby the chainable USB flash-memory drive can be daisy-chained to the downstream chainable USB flash-memory drive.

4. The chainable USB flash-memory drive of claim 3 further comprising:
a daughter-card that has a flash controller and a flash memory mounted thereon;
a socket on the drive substrate, the socket connected to one of the plurality of device ports of the USB hub by the wiring traces;
secondary connectors on the daughter-card for fitting into the socket on the drive substrate,
whereby expansion of flash memory is provided by the daughter-card.

5. The chainable USB flash-memory drive of claim 4 wherein the secondary connectors on the daughter-card comprise metal contact pads along a long edge or along a short edge of the daughter-card, or comprise metal posts or a female connector plug.

6. The chainable USB flash-memory drive of claim 3 further comprising:
a daughter-card that has a flash memory mounted thereon;
an expansion flash controller mounted on the drive substrate and connected to one of the plurality of device ports of the USB hub by the wiring traces;
a socket on the drive substrate, the socket connected to the expansion flash controller by the wiring traces;
secondary connectors on the daughter-card for fitting into the socket on the drive substrate,
whereby expansion flash memory is mounted on the daughter-card but the expansion flash controller is mounted on the drive substrate.

7. The chainable USB flash-memory drive of claim 6 wherein the secondary connectors on the daughter-card comprise metal contact pads along a long edge or along a short edge of the daughter-card, or comprise metal posts or a female connector plug.

8. The chainable USB flash-memory drive of claim 3 wherein the drive substrate is a multi-layer printed-circuit board (PCB).

9. The chainable USB flash-memory drive of claim 3 wherein the male USB connector and the female USB connector are mounted on opposite edges of the drive substrate.

10. A daisy-chainable flash card comprising:
a printed-circuit board (PCB) substrate;
a hub controller mounted on the PCB substrate, the hub controller having a host port, a first device port, and a second device port, the hub controller forwarding commands and data to and from the host port and the first device port or the second device port;
a male connector mounted on the PCB substrate and connected to the host port of the hub controller for insertion into a female connector on a host;
a female connector mounted on the PCB substrate and connected to the first device port of the hub controller, for receiving a male connector on a downstream device;
a flash controller connected to the second device port of the hub controller; and
a flash memory connected to the flash controller, for storing data from the host,
wherein the hub controller routes data from the host to the flash controller for storage by the flash memory when the host addresses local flash memory, but the hub controller routes data from the host to the female connector when the host does not address the local flash memory.

11. The daisy-chainable flash card of claim 10 wherein the flash controller and the flash memory are chips mounted on the PCB substrate.

12. The daisy-chainable flash card of claim 10 wherein the flash controller is mounted on the PCB substrate but the flash memory is mounted on a daughter-card;
further comprising:
a socket on the PCB substrate for receiving a connector on the daughter-card,
wherein the flash memory connects to the flash controller through the connector and the socket.

13. The daisy-chainable flash card of claim 10 wherein both the flash controller and the flash memory are mounted on a daughter-card;
further comprising:
a socket on the PCB substrate for receiving a connector on the daughter-card,
wherein the flash memory is connected to the flash controller which connects to the hub controller through the connector and the socket.

14. The daisy-chainable flash card of claim 10 wherein the male connector is a male USB connector, the female connector is a female USB connector, and the hub controller is a USB hub controller.

15. The daisy-chainable flash card of claim 10 wherein the male connector is a male IEEE 1394 connector, the female connector is a female IEEE 1394 connector, and the hub controller is a IEEE 1394 hub controller.

16. The daisy-chainable flash card of claim 10 wherein the male connector is a male secure-digital connector, the female connector is a female secure-digital connector, and the hub controller is a secure-digital hub controller, or
the male connector is a male compact-flash connector,
the female connector is a female compact-flash connector, and the hub controller is a compact-flash hub controller, or
the male connector is a male memory-stick connector,
the female connector is a female memory-stick connector, and the hub controller is a memory-stick hub controller, or
the male connector is a male multi-media-card connector, the female connector is a female multi-media-card connector, and the hub controller is a multi-media-card hub controller, or
the male connector is a male USB Express Card connector, the female connector is a female USB Express Card connector, and the hub controller is a USB Express Card hub controller, or
the male connector is a male PCI Express Card connector, the female connector is a female PCI Express Card connector, and the hub controller is a PCI Express Card hub controller.

17. An expandable flash card comprising:
substrate means for physically supporting and electrically connecting components mounted thereon;
male protocol connector means, attached to the substrate means, for plugging into a female protocol connector on a host;
female protocol connector means, attached to the substrate means, for receiving a male protocol connector on a downstream device;
protocol hub controller means, mounted on the substrate means, for routing protocol data from the host to an addressed port in a plurality of ports;
first memory means, mounted on the substrate means, for storing the protocol data from the host when the host addresses a port on the protocol hub controller means for the first memory means; and
pass-through means for passing the protocol data from the host through to the female protocol connector means when the host addresses a port that is not in the plurality of ports of the protocol hub controller means, whereby protocol data is stored on the first memory means mounted on the substrate means, or is passed through from the male protocol connector means to the female protocol connector means.

18. The expandable flash card of claim 17 wherein:
when a protocol is a USB protocol, the male protocol connector means is a male USB connector means, the female protocol connector means is a female USB connector means, the protocol hub controller means is a USB hub controller means, and the protocol data is USB data, or
when a protocol is a firewire protocol, the male protocol connector means is a male firewire connector means, the female protocol connector means is a female firewire connector means, the protocol hub controller means is a firewire hub controller means, and the protocol data is firewire data.

19. The expandable flash card of claim 18 further comprising:
socket means, connected to a second of the plurality of ports of the protocol hub controller means, for receiving a daughter-card containing a second flash memory means for storing the protocol data from the host when the host addresses a port on the protocol hub controller means for the second memory means.

20. The expandable flash card of claim 18 wherein the protocol hub controller means further comprises address decode means for detecting and decoding protocol addresses received from the host over protocol data lines.

21. The expandable flash card of claim 20 further comprising a downstream expandable flash card that comprises:
downstream substrate means for physically supporting and electrically connecting components mounted thereon;
downstream male protocol connector means, attached to the downstream substrate means, for plugging into the female protocol connector means;
downstream female protocol connector means, attached to the downstream substrate means, for receiving a male protocol connector on a further downstream device;
downstream protocol hub controller means, mounted on the downstream substrate means, for routing protocol data from the host to an addressed port in a second plurality of ports;
downstream first memory means, mounted on the downstream substrate means, for storing the protocol data from the host when the host addresses a port on the downstream protocol hub controller means for the downstream first memory means; and
downstream pass-through means for passing the protocol data from the host through to the downstream female protocol connector means when the host addresses a port that is not in the second plurality of ports of the downstream hub controller means and is not in the plurality of ports of the protocol hub controller means, wherein the downstream expandable flash card is removable from the expandable flash card.
